(19) United States
(12) Patent Application Publication
(10) Pub. No.: US 2021/0132793 A1
(43) Pub. Date: May 6, 2021

(54) Mobile Display Device with Multiple Display Panels

(71) Applicants: David W. Burns, San Jose, CA (US); Debra Brubaker Burns, San Jose, CA (US)

(72) Inventors: David W. Burns, San Jose, CA (US); Debra Brubaker Burns, San Jose, CA (US)

(21) Appl. No.: 17/083,247

(22) Filed: Oct. 28, 2020

Related U.S. Application Data
(60) Provisional application No. 62/926,930, filed on Oct. 28, 2019.

(51) Int. Cl. G06F 3/0488; G06F 1/16

(52) U.S. Cl. CPC G06F 3/04886; G06F 1/1681; G06F 1/1679; G06F 2200/1637; G06F 1/1654; G06F 2200/1614; G06F 1/1677

(57) ABSTRACT

A mobile display device may include a first display panel with a display screen having a viewing surface, a second display panel with a second display screen having a viewing surface, and a multi-position hinge coupling the first display panel to the second display panel. The first display panel and the second display panel may be configurable in a closed configuration, a paperback configuration, a tablet configuration, or a back-to-back configuration.

### CROSS-REFERENCE TO RELATED APPLICATIONS

This patent application claims priority to U.S. Provisional Patent Application No. 62/926,930 filed on Oct. 28, 2019 entitled “Mobile Display Device with Multiple Display Panels” and U.S. Provisional Patent Application No. 62/927,045 filed on Oct. 28, 2019 entitled “Mobile Display Device with Dual Display Panels and Segregated System Components”, each hereby incorporated by reference in their entirety for all purposes.

### FIELD OF THE INVENTION

This patent disclosure relates generally to the field of wireless mobile devices and more specifically to wireless devices with multiple display panels.

### BACKGROUND OF THE INVENTION

Current wireless multimedia devices such as cell phones and tablet computers are generally configured with a single display panel and touchscreen that a user may view and interact with. The single display screen limits the user experience and allowed viewing configurations.

### BRIEF SUMMARY OF THE INVENTION

A mobile display device may include a first display panel having a display screen with a viewing surface, a second display panel having a display screen with a viewing surface, and a multi-position hinge coupling the first display panel to the second display panel. The first display panel and the second display panel may be configurable in a closed configuration, a paperback configuration, a tablet configuration, or a back-to-back configuration.

The first display panel may be enclosed within a first enclosure and the second display panel may be enclosed within a second enclosure. The first enclosure and the second enclosure may be electrically and mechanically coupled through the multi-position hinge. A hinge-angle detector may be coupled to the multi-position hinge. Display information may be provided to either or both of the first display screen or the second display screen based on a detected hinge angle from the hinge-angle detector.

When in the closed configuration, the viewing surface of the first display screen may be positioned against the viewing surface of the second display screen with a closed hinge angle of approximately zero degrees. When in the paperback configuration, the viewing surface of the first display screen and the viewing surface of the second display screen may be positioned at a paperback hinge angle between about 60 degrees and 180 degrees, where the first display screen and the second display screen may be simultaneously viewable by a user of the mobile display device. The tablet configuration may include the viewing surface of the first display screen and the viewing surface of the second display screen positioned at a tablet hinge angle that is nominally 180 degrees, where the first display screen and the second display screen lie substantially in a plane and both display screens may be simultaneously viewable by a user of the mobile display device. The back-to-back configuration may include the viewing surface of the first display screen facing a first direction and the viewing surface of the second display screen facing a second direction opposite the first direction with a back-to-back hinge angle that is nominally 360 degrees. The second display panel may include a touchscreen so that when configured in the back-to-back configuration, a software application or a software-generated window running in the mobile display device may be configured to allow a touch of a user on the backside touchscreen to effect a change on the first display panel.

The first display screen and the second display screen may include at least one of an LED display, an OLED display, an AMOLED display, a backlit display, a front-lit display, a touchscreen, an in-display fingerprint sensor, a through-display fingerprint sensor, or other display device.

The mobile display device may include one or more orientation sensors configured to detect and aid in determining a current orientation of the mobile display device. Display information may be provided to one or both of the first display screen and the second display screen based on one or more orientation sensor signals from the orientation sensors. The display information may be generated and provided to one or both of the first display screen and the second display screen in a portrait mode, a landscape mode, a split mode, a closed mode, a paperback viewing mode, a tablet viewing mode, a back-to-back viewing mode or other viewing mode.

A method of operating a mobile display device may include the steps of positioning the mobile display device in a closed configuration, a paperback configuration, a tablet configuration or a back-to-back configuration; detecting an orientation of the mobile display device and a hinge angle of a multi-position hinge; generating display information for one or both of a first display panel and a second display panel of the mobile display device; and providing display information to one or both of the first display panel and the second display panel based on the orientation of the mobile display device and the hinge angle of the multi-position hinge.

A system for operating a mobile display device may include a first display panel, a second display panel, a multi-position hinge coupling the first display panel to the second display panel, and a processor. The processor may be configured to allow detecting an orientation of the mobile display device and a hinge angle of the multi-position hinge, generating display information for one or both of the first display panel and the second display panel, and providing display information to one or both of the first display panel and the second display panel based on the orientation of the mobile display device and the hinge angle when the mobile display device is positioned in a closed configuration, a paperback configuration, a tablet configuration, or a back-to-back configuration.

Computer-readable medium for operating a mobile display device may include computer-readable instructions for detecting an orientation of the mobile display device and a hinge angle of a multi-position hinge, generating display information for one or both of a first display panel and a second display panel of the mobile display device, and providing display information to one or both of the first display panel and the second display panel based on the orientation of the mobile display device and the hinge angle when the mobile display device is positioned in a closed configuration, a paperback configuration, a tablet configuration, or a back-to-back configuration.

### BRIEF DESCRIPTION OF THE DRAWINGS

FIG. 1 shows a mobile display device with multiple display panels in various configurations including a closed configuration, a paperback configuration, a tablet configuration and a back-to-back configuration.

FIG. 2 shows an exploded view of a mobile display device with two display panels and a multi-position hinge coupling the first display panel to the second display panel.

FIG. 3A through FIG. 3D illustrate various configurations of a mobile display device including a closed configuration, a paperback configuration, a tablet configuration and a back-to-back configuration.

FIG. 4A through FIG. 4E illustrate various modes of a mobile display device including a portrait mode, a landscape mode, a split mode, a closed mode, a paperback viewing mode, a tablet viewing mode and a back-to-back viewing mode.

FIG. 5 illustrates various configurations of a mobile display device having a quartet of display panels.

FIG. 6 illustrates a side view of a multi-position hinge coupling two display panels.

FIG. 7 shows a perspective view of one implementation of a multi-position hinge for a mobile display device having multiple display panels.

FIG. 8 shows a block diagram illustrating a method of operating a mobile display device having multiple display panels.

FIG. 9 shows a block diagram of a system for operating a mobile display device having multiple display panels.

FIG. 10 illustrates a computer-readable medium for operating a mobile display device having multiple display panels.

### DETAILED DESCRIPTION OF THE INVENTION

The present invention allows an improved experience for users of mobile display devices such as cell phones and tablet computers. Multiple display screens in a foldable display device increase the number of viewing configurations of wireless multimedia display devices to accommodate a variety of user preferences and viewing environments. The mobile display devices described herein have applications for online and standalone gaming, e-book readers, ecommerce, social media, distance learning, notebook computers, video conferencing, and conventional texting and telephonic calls.

Mobile display devices with multiple display panels allow multiple configurations such as a closed configuration, a paperback configuration, a tablet configuration or a back-to-back configuration. The display panels may be configured within separate enclosures that are coupled with a multi-position hinge. One or more orientation sensors and hinge-angle detectors may aid in determining the configuration of the mobile display device and providing display information to the display panels. The display information may be generated and provided to the display panels while in a closed, paperback, tablet or back-to-back configuration based on the orientation sensor signals and detected hinge angle.

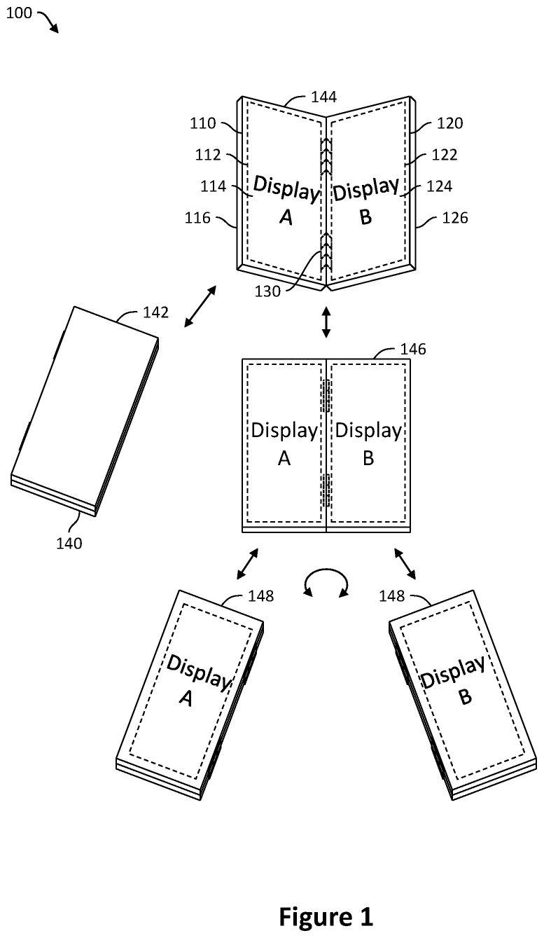

FIG. 1 shows a mobile display device 100 with multiple display panels 110, 120 in various configurations 140 including a closed configuration 142, a paperback configuration 144, a tablet configuration 146, and a back-to-back configuration 148. One display panel 110 may include a display screen 112 with a viewing surface 114 positioned in an enclosure 116. A second display panel 120 may include a display screen 122 with a viewing surface 124 positioned in an enclosure 126. One or more multi-position hinges 130 may electrically and mechanically couple enclosure 116 and display panel 110 to enclosure 126 and display panel 120.

Mobile display device 100 may be configured in closed configuration 142 where viewing surface 114 of display screen 112 is positioned against viewing surface 124 of display screen 122. Closed configuration 142 may provide physical and mechanical protection of display screens 112, 122 while mobile display device 100 is not in use. Alternatively, mobile display device 100 may be configured in paperback configuration 144 where viewing surface 114 of display screen 112 and viewing surface 124 of display screen 122 are positioned at a paperback hinge angle where display screen 112 and display screen 122 may be simultaneously viewable by a user of mobile display device 100. Paperback configuration 144 may have a paperback hinge angle between about 60 degrees and 180 degrees to allow the user to view or read from either viewing surface 114 or viewing surface 124 in a paperback viewing mode, allowing comfortable, compact reading with an increased level of privacy and intimacy compared to a single-display device.

Alternatively, mobile display device 100 may be configured in tablet configuration 146 where viewing surface 114 of display screen 112 and viewing surface 124 of display screen 122 are positioned at a tablet hinge angle such that viewing surface 114 of display screen 112 and viewing surface 124 of display screen 122 lie substantially in a common viewing plane. Tablet configuration 146 may have a tablet hinge angle of nominally 180 degrees to allow a user to view both viewing surfaces 114, 124 simultaneously as in a single-screen tablet computer, providing a larger viewable area compared to a single-screen tablet computer and allowing mobile display device 100 to be comfortably placed on a flat surface for writing on or otherwise interacting with display screens 112, 122.

Alternatively, mobile display device 100 may be configured in back-to-back configuration 148 where viewing surfaces 114, 124 of display screens 112, 122 face opposite directions. Back-to-back configuration 148 may have a back-to-back hinge angle of nominally 360 degrees to allow a user to view either display screen 112 or display screen 122 much as in a single-screen mobile device. While a user of mobile display device 100 in back-to-back configuration 148 may normally view and interact with only one viewing surface 114, 124 at a time, back-to-back configuration 148 allows different software applications and viewable materials to run simultaneously on either side of mobile display device 100, allowing the user to interact with one side while occasionally rotating or flipping mobile display device 100 to view and interact with the opposite side. In some implementations, one or more of the display panels 110, 120 may include a touchscreen. A software application or a software-generated window running in mobile display device 100 may be configured to allow a touch of a user on the touchscreen of one display panel to effect a change on the other display panel. For example, when mobile display device 100 is configured in back-to-back configuration 148, a user such as a gamer may press, swipe or otherwise touch a backside touchscreen to activate a function on the front-side display so that the finger touching the backside touchscreen does not occlude the user's view of the front-side display. The software application or window may be configured to display a specific icon or other graphic on either or both the backside and front-side displays to correlate a backside touch with a front-side function.

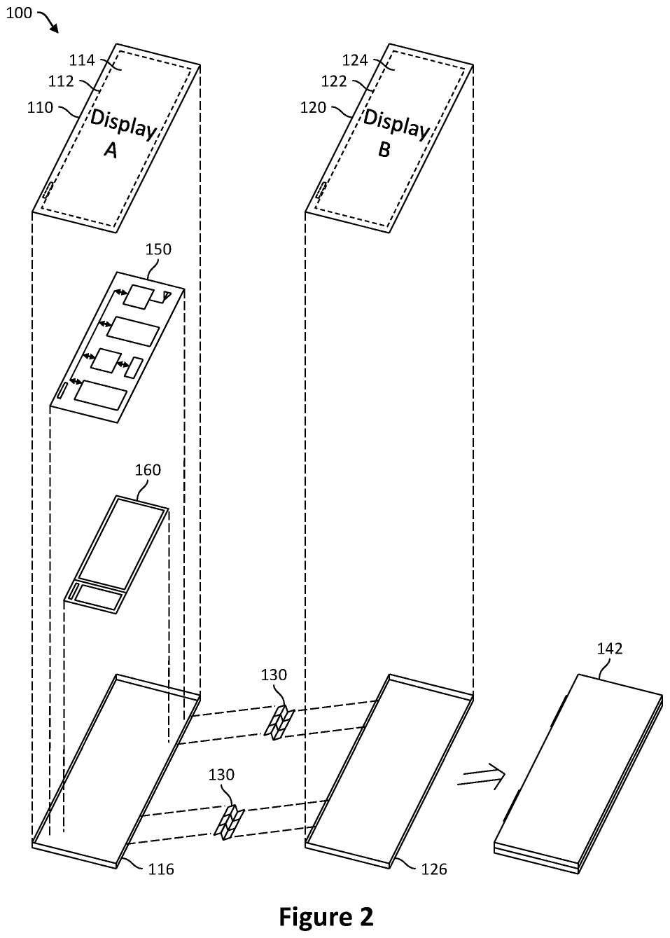

FIG. 2 shows an exploded view of mobile display device 100 with display panels 110, 120 and multi-position hinge 130 coupling display panel 110 to display panel 120. Display panel 110 with display screen 112 and viewing surface 114 may be housed in enclosure 116 along with a main PCB (printed circuit board) 150 including various processors, memory, components, switches and connectors. Enclosure 116 may include one or more battery modules 160. Display panel 120 with display screen 122 and viewing surface 124 may be housed in enclosure 126. Enclosure 116 may be coupled to enclosure 126 with one or more multi-position hinges 130. With assembly complete, mobile display device 100 may be configured in closed configuration 142 for shipping, storage and usage. Display panels 110, 120 may include one or more LED displays, OLED displays, AMOLED displays, backlit displays, front-lit displays, touchscreens, in-display fingerprint sensors, through-display fingerprint sensors, or other display devices. Fingerprint and finger detection sensors may be capacitive, optical or ultrasonic. The display panels and display screens described herein are substantially rigid and separable. One or more multi-position hinges 130 may physically separate display panels 110, 120 to allow viewing surfaces 114, 124 of display screens 112, 122 to be continuously unfolded from a closed position to a fully open flat position and further to a completely back-to-hack configuration.

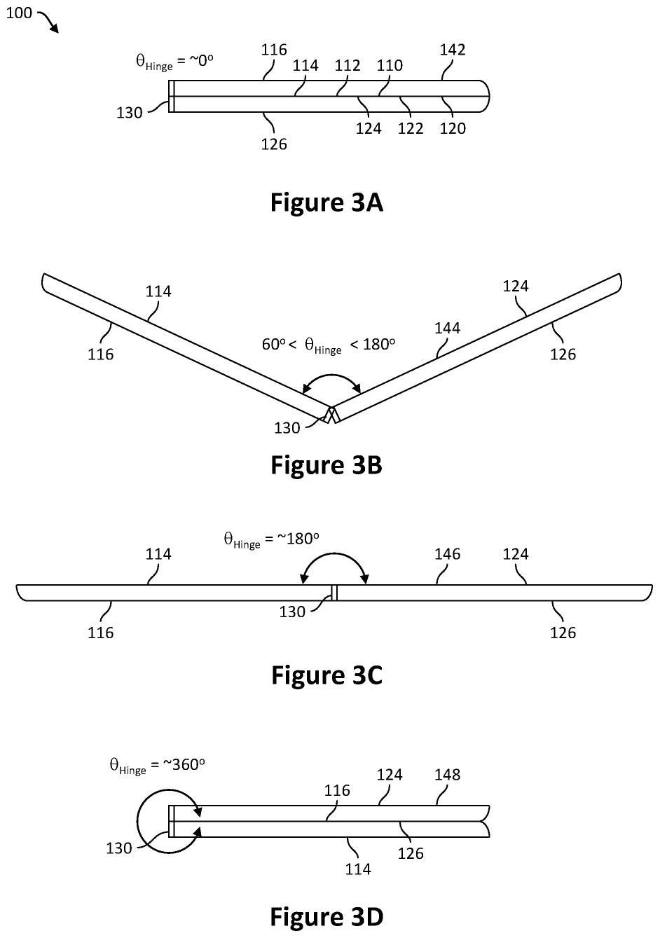

FIG. 3A through FIG. 3D illustrate various configurations of mobile display device 100 including closed configuration 142, paperback configuration 144, tablet configuration 146 and back-to-back configuration 148. FIG. 3A shows a side view of mobile display device 100 in closed configuration 142, with viewing surface 114 of display screen 112 within enclosure 116 positioned against viewing surface 124 of display screen 122 within enclosure 126. Multi-position hinge 130 may mechanically and electrically couple enclosure 116 and display panel 110 to enclosure 126 and display panel 120. In closed configuration 142, the closed hinged angle is nominally zero degrees. FIG. 3B shows a side view of mobile display device 100 in paperback configuration 144 with a paperback hinge angle between about 60 degrees and about 180 degrees. Viewing surface 114 of enclosure 116 and viewing surface 124 of enclosure 126 may be simultaneously viewable by a user when positioned in paperback configuration 144. FIG. 3C shows a side view of mobile display device 100 in tablet configuration 146 with a tablet hinge angle of about 180 degrees. Viewing surface 114 of enclosure 116 and viewing surface 124 of enclosure 126 lie substantially in a common plane and may be simultaneously viewable by a user of mobile display device 100. FIG. 3D shows a side view of mobile display device 100 in back-to-back configuration 148 with a back-to-back hinge angle of about 360 degrees. Viewing surface 114 of enclosure 116 and viewing surface 124 of enclosure 126 may face opposite directions when positioned in back-to-back configuration 148. When positioned in back-to-back configuration 148, either viewing surface 114 or viewing surface 124 may be viewed by a user by flipping or rotating mobile display device 100 accordingly. Alternatively, software running on mobile display device 100 may be configured so that a user may press, swipe or otherwise touch the backside display to activate a function or otherwise effectuate a change on the front-side display.

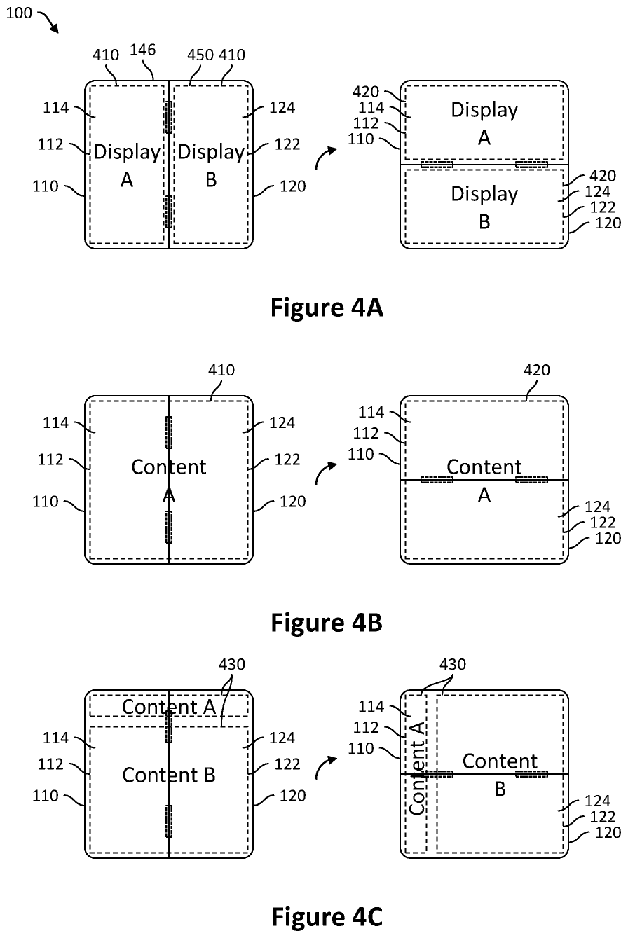

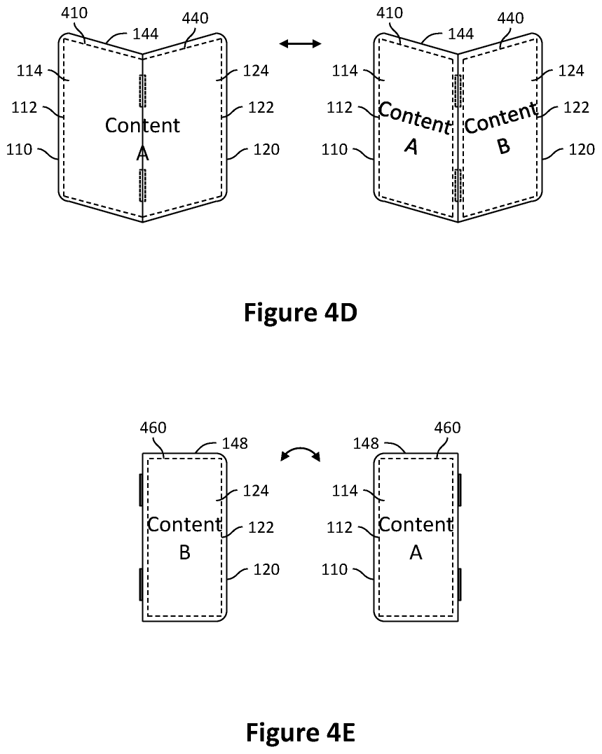

FIG. 4A through FIG. 4E illustrate various configuration and display modes of mobile display device 100 including a portrait mode 410, a landscape mode 420, a split mode 430, a paperback viewing mode 440, a tablet viewing mode 450 and a back-to-back viewing mode 460. FIG. 4A illustrates mobile display device 100 in tablet configuration 146 operating in tablet viewing mode 450. Display information may be provided to display screen 112 of display panel 110 in portrait mode 410 and display information may be provided to display screen 122 of display panel 120 also in portrait mode 410. Mobile display device 100 may be rotated and updated display information may be provided to viewing surfaces 114, 124 of display screens 112, 122 in landscape mode 420. FIG. 4B shows display information provided to display screens 112, 122 in portrait mode 410 and in landscape mode 420. FIG. 4C shows display information provided to display screens 112, 122 in split mode 430, where a portion of the display information is provided near the top or side of mobile display device 100 and the remainder of the display information is provided elsewhere on display screens 112, 122. FIG. 4D shows mobile display device 100 operating in paperback viewing mode 440, with display information provided to display screens 112, 122 in paperback viewing mode 440 either as single content or split content. FIG. 4E shows mobile display device 100 operating in back-to-back viewing mode 460, with display information viewable on either display screen 112 or display screen 122. A closed mode (not shown) may be invoked when mobile display device 100 is positioned in a closed configuration such that black or no display information is provided to display screens 112, 122 when viewing surface 114 of display screen 112 is positioned against viewing surface 124 of display screen 122.

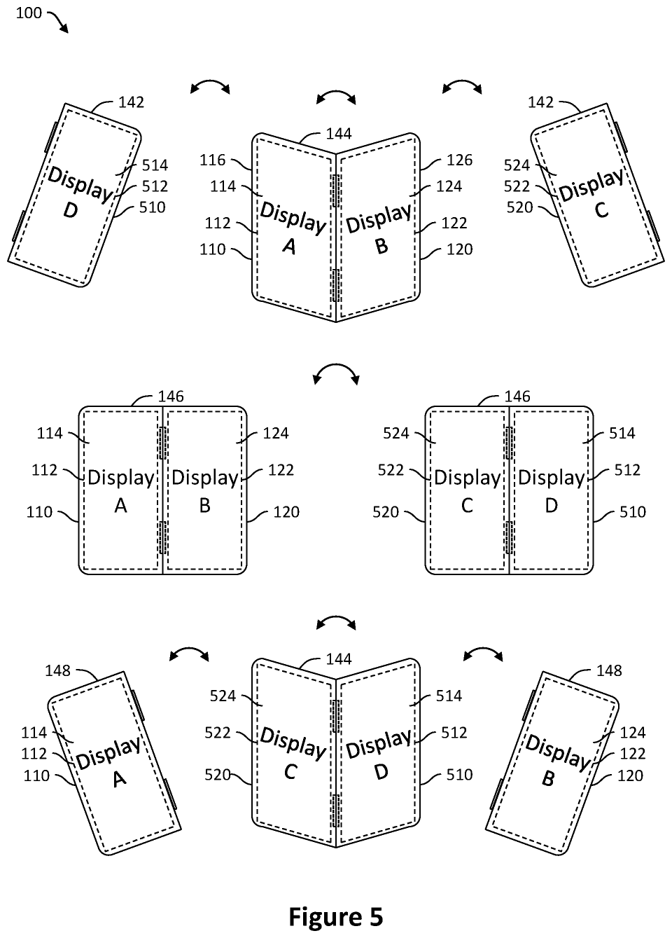

FIG. 5 illustrates various configurations of a mobile display device 100 having a quartet of display panels 110, 120, 510, 520. Two display panels 110, 510 with display screens 112, 512 and viewing surfaces 114, 514 may be housed on opposite sides of enclosure 116. A second group of display panels 120, 520 with display screens 122, 522 and viewing surfaces 124, 524 may be housed on either side of a second enclosure 126. The various configurations shown include a closed configuration 142, a paperback configuration 144, a tablet configuration 146 and a back-to-back configuration 148. With four display screens 112, 122, 512, 522, display information may be provided to the exterior facing screens for viewing when mobile display device 100 is positioned in closed configuration 142 or back-to-back configuration 148. Similarly, when positioned in either paperback configuration 144 or tablet configuration 146, display information may be provided to any or all of display screens 112, 122, 512, 522 in portrait mode 410, landscape mode 420, or other display mode.

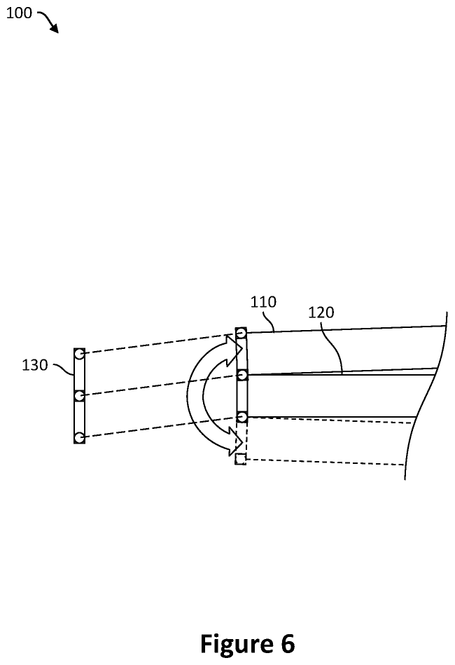

FIG. 6 illustrates a side view of multi-position hinge 130 coupling two display panels 110, 120. A portion of multi-position hinge 130 may be coupled to an enclosure housing display panel 110 and another portion of multi-position hinge 130 may be coupled to a second enclosure housing display panel 120. Multi-position hinge 130 may electrically and mechanically couple display panel 110 and display panel 120, allowing rotation of the two display panels nearly a full turn as mobile display device 100 is reconfigured from a closed configuration to a back-to-back configuration. Mechanical coupling may be provided through one or more joints that allow rotational freedom while retaining positional contact between the two display panels. The joints may be augmented with resistive features or articulated surfaces that retain the enclosures in a preferred configuration while allowing mobile device 100 to be closed or placed in another preferred configuration during use. Electrical coupling may be provided through one or more wires, sliding electrical contacts, flexible printed circuit cables or the like that pass through one or more portions of multi-position hinge 130, allowing electrical connectivity while retaining mechanical rotation capability.

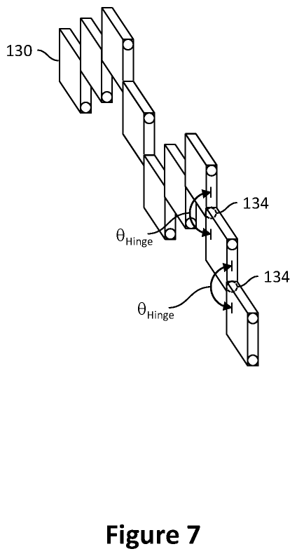

FIG. 7 shows a perspective view of one implementation of multi-position hinge 130 for a mobile display device having multiple display panels. Multi-position hinge 130 allows mechanical and electrical connections between two enclosures housing the display panels. One or more hinge-angle detectors 134 such as a rotational angle sensor or a magnetic proximity sensor may be coupled to multi-position hinge 130. Hinge-angle detectors 134 may provide one or more hinge-angle signals that may be used to determine the hinge angle between segments of multi-position hinge 130. The hinge angle may be used to determine whether the mobile display device is configured in a closed, paperback, tablet or back-to-back configuration so that display information may be provided to the display screens accordingly. Alternatively or in addition to, one or more orientation sensors within the mobile display device may be configured to detect a current orientation of the mobile display device and to provide display information to the display screens based on one or more orientation sensor signals from the orientation sensors.

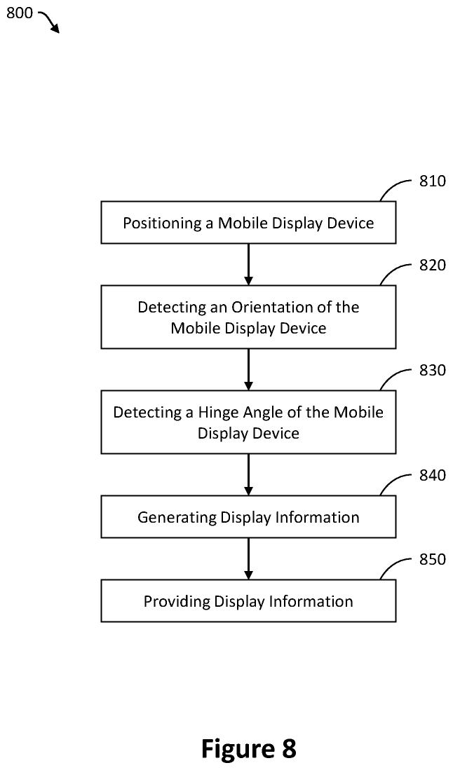

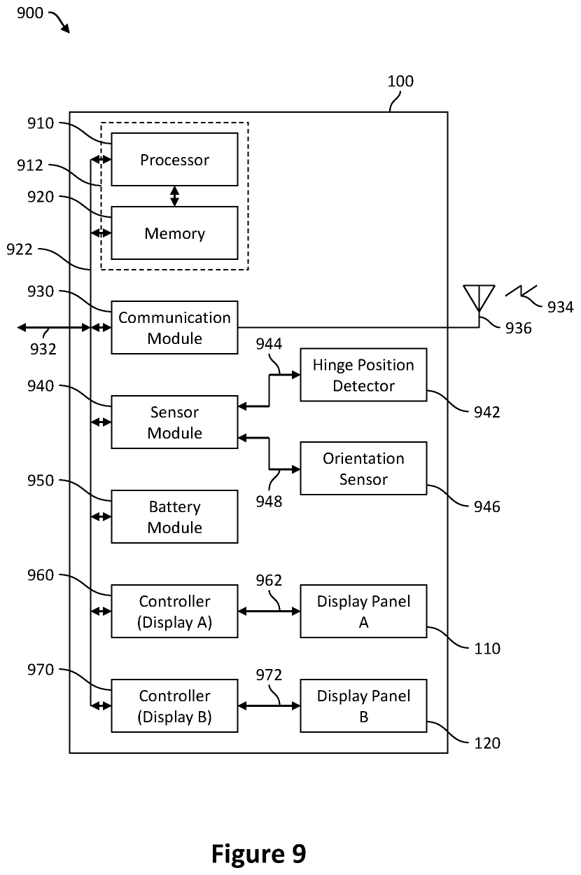

FIG. 8 shows a block diagram illustrating a method 800 of operating a mobile display device having multiple display panels. Method 800 may include positioning the mobile display device in a closed configuration, a paperback configuration, a tablet configuration, or a back-to-back configuration, as shown in block 810. Method 800 may include detecting an orientation of the mobile display device as shown in block 820 and/or detecting a hinge angle of a multi-position hinge coupling the display panels of the mobile display device as shown in block 830. The hinge angle may be determined from one or hinge-angle signals detected from the multi-position hinge. Alternatively or in addition to, the hinge angle and/or the orientation of the mobile display device may be determined from one or more orientation sensor signals detected from one or more orientation sensors mounted in one or both enclosures of the mobile display device. The hinge-angle and/or orientation sensor signals may be used to determine the configuration of the mobile display device, such as a closed configuration, a paperback configuration, a tablet configuration, or a back-to-back configuration.

Method 800 may include generating display information for one or more of the display panels in the mobile display device as shown in block 840 and providing the generated display information to the display panels based on the orientation of the mobile display device and/or the hinge angle of the multi-position hinge, as shown in block 850. The display information may be generated and provided to one or more of the display panels in a portrait mode, a landscape mode, a split mode, a closed mode, a paperback viewing mode, a tablet viewing mode, or a back-to-back viewing mode. A software application or a software-generated window running in the mobile display device may be configured to allow a touch of a user on the backside display panel to activate a function or otherwise effectuate a change on the front-side display panel when operating in a back-to-back viewing mode.

FIG. 9 shows a block diagram of a system 900 for operating mobile display device 100 having multiple display panels 110, 120. System 900 may include display panels 110, 120 and a multi-position hinge coupling display panel 110 to display panel 120. System 900 may include one or more processors 910, operating systems 912 and memory 920. Data, power and control signals may be conveyed amongst various components of system 900 via one or more electrical buses 922. One or more communication modules 930 may transmit and receive signals via one or more wired communication links 932 or wireless communication links 934 using one or more antennas 936. One or more sensor modules 940 may include one or more hinge-position detectors 942 to provide one or more hinge-angle signals 944 and/or one or more orientation sensors 946 to provide one or more orientation sensor signals 948. One or more battery modules 950 may provide electrical power for system 900 to allow portable and mobile use. A dedicated controller 960 may provide display information 962 to display panel 110 and a second dedicated controller 970 may provide display information 972 to display panel 120. Display controllers 960, 970 may be configured to detect finger touches and swipes of a user on display panels 110, 120 accordingly.

Processor 910 of system 900 may be configured to allow detecting an orientation of mobile display device 100 and/or a hinge angle of the multi-position hinge, generating display information 962, 972 for display panels 110, 120, and providing display information 962, 972 to one or both display panels 110, 120 based on the orientation of mobile display device 100 and the hinge angle when mobile display device 100 is positioned in a closed configuration, a paperback configuration, a tablet configuration, or a back-to-back configuration.

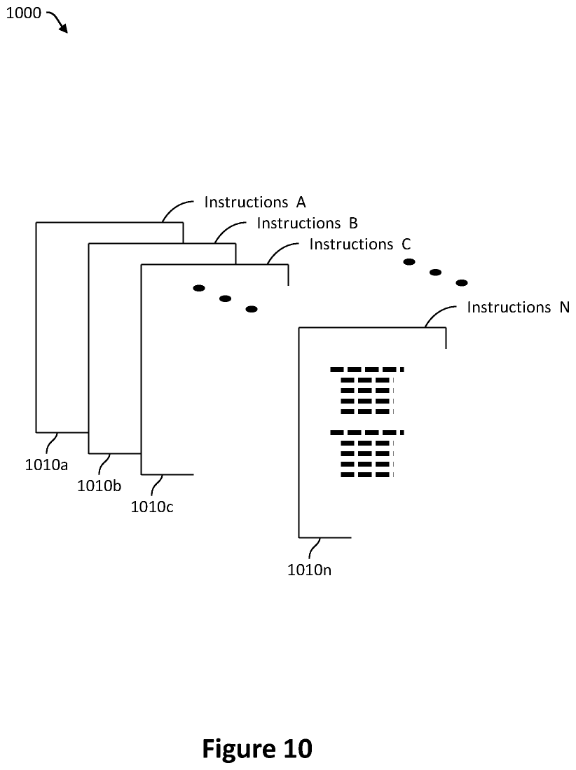

FIG. 10 illustrates a computer-readable medium 1000 for operating a mobile display device having multiple display panels. Computer-readable medium 1000 may include computer-readable instructions or blocks of instructions 1010a, 1010b, 1010c . . . 1010n containing one or more lines of computer code. The computer code may be executed by one or more processors within the mobile display device and enable detecting an orientation of the mobile display device and a hinge angle of a multi-position hinge, generating display information for one or both of a first display panel and a second display panel of the mobile display device, and providing display information to the display panels. The display information may be based on the orientation of the mobile display device and/or the hinge angle when the mobile display device is positioned in a closed configuration, a paperback configuration, a tablet configuration, or a back-to-back configuration. When operating in a back-to-back viewing mode, the computer code may be configured to allow a software application or a software-generated window running in the mobile display device to detect a touch of a user on the backside display and to activate a function or otherwise effectuate a change on the front-side display panel.

While various implementations have been described above, it should be understood that the implementations have been presented by way of example and not limitation. The breadth and scope of the present disclosure should not be limited by any of the implementations described above but should be defined in accordance with the following claims, subsequently submitted claims, and their equivalents.

What is claimed is:

1. A mobile display device, the mobile display device comprising:
a first display panel including a first display screen having a viewing surface;
a second display panel including a second display screen having a viewing surface; and
a multi-position hinge coupling the first display panel to the second display panel; wherein the first display panel and the second display panel are configurable in one of a closed configuration, a paperback configuration, a tablet configuration, or a back-to-back configuration.

2. The mobile display device of claim 1, wherein the first display panel is enclosed within a first enclosure and the second display panel is enclosed within a second enclosure.

3. The mobile display device of claim 2, wherein the first enclosure and the second enclosure are electrically and mechanically coupled through the multi-position hinge.

4. The mobile display device of claim 1, wherein the closed configuration comprises the viewing surface of the first display screen positioned against the viewing surface of the second display screen.

5. The mobile display device of claim 1, wherein the paperback configuration comprises the viewing surface of the first display screen and the viewing surface of the second display screen positioned at a paperback hinge angle; wherein the first display screen and the second display screen are simultaneously viewable by a user of the mobile display device; and wherein the paperback hinge angle is between about 60 degrees and 180 degrees.

6. The mobile display device of claim 1, wherein the tablet configuration comprises the viewing surface of the first display screen and the viewing surface of the second display screen positioned at a tablet hinge angle; wherein the first display screen and the second display screen lie substantially in a plane and are simultaneously viewable by a user of the mobile display device; and wherein the tablet hinge angle is nominally 180 degrees.

7. The mobile display device of claim 1, wherein the back-to-back configuration comprises the viewing surface of the first display screen facing a first direction and the viewing surface of the second display screen facing a second direction opposite the first direction; wherein a back-to-back hinge angle of the multi-position hinge is nominally 360 degrees; wherein the second display panel includes a touchscreen; and wherein a software application or a software-generated window running in the mobile display device is configurable to allow a touch of a user on the touchscreen to effect a change on the first display panel.

8. The mobile display device of claim 1, wherein the first display screen and the second display screen comprise at least one of an LED display, an OLED display, an AMOLED display, a backlit display, a front-lit display, a touchscreen, an in-display fingerprint sensor, a through-display fingerprint sensor, or a display device.

9. The mobile display device of claim 1, further comprising:
at least one orientation sensor configured to detect a current orientation of the mobile display device; wherein display information is provided to one or both of the first display screen and the second display screen based on an orientation sensor signal from the at least one orientation sensor.

10. The mobile display device of claim 9, wherein the display information provided to one or both of the first display screen and the second display screen is provided in one of a portrait mode, a landscape mode, a split mode, a closed mode, a paperback viewing mode, a tablet viewing mode, or a back-to-back viewing mode.

11. The mobile display device of claim 1, further comprising:
a hinge-angle detector coupled to the multi-position hinge, wherein display information provided to either or both of the first display screen and the second display screen is based on a detected hinge angle from the hinge-angle detector.

12. A method of operating a mobile display device, the method comprising:
positioning the mobile display device in one of a closed configuration, a paperback configuration, a tablet configuration, or a back-to-back configuration;
detecting an orientation of the mobile display device and a hinge angle of a multi-position hinge;
generating display information for one or both of a first display panel and a second display panel of the mobile display device; and
providing display information to one or both of the first display panel and the second display panel based on the orientation of the mobile display device and the hinge angle of the multi-position hinge.

13. The method of claim 12, wherein a viewing surface of the first display panel is positioned against a viewing surface of the second display panel when the mobile display device is positioned in the closed configuration.

14. The method of claim 12, wherein a viewing surface of the first display panel and a viewing surface of the second display panel are simultaneously viewable by a user of the mobile display device and wherein the hinge angle is between about 60 degrees and 180 degrees when the mobile display device is positioned in the paperback configuration.

15. The method of claim 12, wherein a viewing surface of the first display panel and a viewing surface of the second display panel lie substantially in a plane and wherein the hinge angle is nominally 180 degrees when the mobile display device is positioned in the tablet configuration.

16. The method of claim 12, wherein a viewing surface of the first display panel faces a first direction and a viewing surface of the second display panel faces a second direction opposite the first direction when the mobile display device is positioned in the back-to-back configuration; wherein the second display panel includes a touchscreen; and wherein a software application or a software-generated window running in the mobile display device is configurable to allow a touch of a user on the touchscreen to activate a function on the first display panel.

17. The method of claim 12, wherein the orientation of the mobile display device is determined from at least one orientation sensor of the mobile display device.

18. The method of claim 12, wherein display information for one or both of the first display panel and the second display panel is generated in one of a portrait mode, a landscape mode, a split mode, a closed mode, a paperback viewing mode, a tablet viewing mode, or a back-to-back viewing mode.

19. A system for operating a mobile display device, the system comprising:
a first display panel, a second display panel and a multi-position hinge coupling the first display panel to the second display panel; and
a processor; wherein the processor is configured to allow:
detecting an orientation of the mobile display device and a hinge angle of the multi-position hinge;
generating display information for one or both of the first display panel and the second display panel; and
providing display information to one or both of the first display panel and the second display panel based on the orientation of the mobile display device and the hinge angle when the mobile display device is positioned in one of a closed configuration, a paperback configuration, a tablet configuration, or a back-to-back configuration.

20. Computer-readable medium for operating a mobile display device, the computer-readable medium including computer-readable instructions for:
detecting an orientation of the mobile display device and a hinge angle of a multi-position hinge;
generating display information for one or both of a first display panel and a second display panel of the mobile display device; and
providing display information to one or both of the first display panel and the second display panel based on the orientation of the mobile display device and the hinge angle when the mobile display device is positioned in one of a closed configuration, a paperback configuration, a tablet configuration, or a back-to-back configuration.
